(19) United States
(12) Patent Application Publication
(10) Pub. No.: US 2013/0061422 A1
(43) Pub. Date: Mar. 14, 2013

(54) MULTI-OPERATIONAL MODE FLUID EXTRACTORS AND ASSOCIATED METHODS OF USE AND MANUFACTURE

(71) Applicants: Richard A. Black, Bellingham, WA (US); William Bruders, Sedro Woolley, WA (US); Kevin A. Wolfe, San Marcos, CA (US); Larry White, Mount Vernon, WA (US)

(72) Inventors: Richard A. Black, Bellingham, WA (US); William Bruders, Sedro Woolley, WA (US); Kevin A. Wolfe, San Marcos, CA (US); Larry White, Mount Vernon, WA (US)

(73) Assignee: Dri-Eaz Products, Inc, Burlington, WA (US)

(21) Appl. No.: 13/599,733

(22) Filed: Aug. 30, 2012

Related U.S. Application Data
(60) Provisional application No. 61/529,898, filed on Aug. 31, 2011.

(51) Int. Cl. A47L 9/02; B23P 11/00

(52) U.S. Cl. 15/414; 29/428

(57) ABSTRACT

Multi-operational mode fluid extractors and associated methods are disclosed herein. An extractor configured in accordance with a particular embodiment includes a waste fluid tank positioned to receive extracted waste fluid and an air mover proximate to the waste fluid tank. A first airflow connector couples the air mover to the waste fluid tank for drawing a vacuum in the waste fluid tank. A second airflow connector is operably coupled to the waste fluid tank and positioned to be coupled to a suction source that is spaced apart from the extractor. In particular embodiments, heat from air moving through the air mover can be transferred from the air mover cavity into the waste fluid tank.

### CROSS-REFERENCE TO RELATED APPLICATION

The present application claims priority to U.S. Provisional Application No. 61/529,898, filed Aug. 31, 2011, and incorporated herein by reference.

### TECHNICAL FIELD

The present disclosure is directed generally to fluid extractors, systems, and associated methods and, more specifically, to fluid extractors that can operate alone or in combination with additional external suction sources.

### BACKGROUND

Extraction or vacuum systems are frequently used to remove water or other fluids from water-damaged buildings. For example, vacuum systems are often used to extract water from homes and buildings that have been flooded due to heavy rains, a broken pipe, sprinklers that have been activated in response to a fire, etc. Removing unwanted fluids from such buildings helps the buildings dry and also prevents mold, unpleasant odors, and/or other undesirable consequences from wet conditions. Existing systems for extracting water and/or cleaning supplies from flooring surfaces include portable devices and truck or van based devices.

### BRIEF DESCRIPTION OF THE DRAWINGS

FIG. 1 is a partially schematic side view of an extraction system configured in accordance with an embodiment of the present disclosure.

FIG. 2A is a top isometric view and FIG. 2B is a bottom isometric view of an extractor configured in accordance with embodiments of the present disclosure.

FIG. 3A is a side cross-sectional view taken substantially along line 3-3 of FIG. 2A.

FIG. 3B is a top isometric view of waste fluid tank configured in accordance with embodiments of the present disclosure.

FIG. 3C is a top isometric view of an upper portion of the housing and a pressure relief valve configured in accordance with embodiments of the present disclosure.

FIGS. 4A and 4B are bottom plan views of an extractor configured in accordance with embodiments of the present disclosure.

FIG. 4C is a bottom plan view of an extractor configured in accordance embodiments of the present disclosure

### DETAILED DESCRIPTION

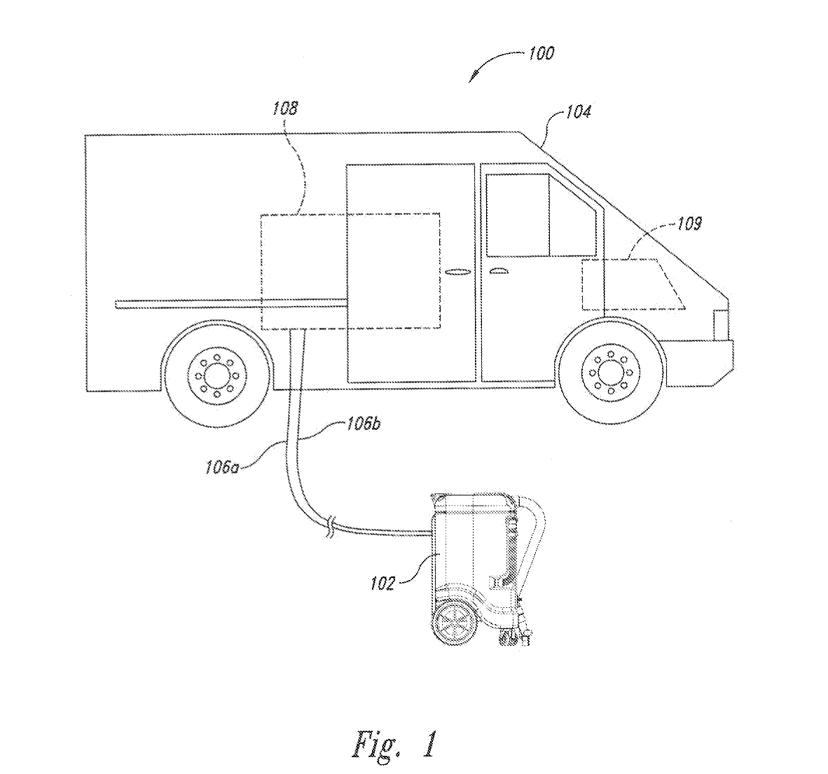

The present disclosure is directed generally to extractors, systems, assemblies, and associated methods of manufacture and operation for removing water or other fluids (e.g., liquids) from buildings or other structures. Although embodiments included herein are described with reference to various surfaces in buildings, one of ordinary skill in the art will appreciate that the embodiments described herein can be used with various types of flooring surfaces and materials. The following description identifies specific details with reference to FIGS. 1-4C to provide a thorough understanding of various embodiments of the disclosure. Other details describing well-known structures or processes often associated with extractors, however, are not described below to avoid unnecessarily obscuring the description of various embodiments of the disclosure. Moreover, although the following disclosure sets forth several embodiments of different aspects of the disclosure, other embodiments can have different configurations and/or different components than those described in this section. In addition, further embodiments of the disclosure may be practiced without several of the details described below, while still other embodiments of the disclosure may be practiced with additional details and/or features.

FIG. 1 is a partially schematic side view of a system 100 that can be used to remove water or other fluids from a floor surface or other environment. In the illustrated embodiment, the system 100 includes a portable extractor 102 that is optionally operably coupled to a vehicle 104 via one or more connection lines 106 (identified individually as a first connection line 106a and a second connection line 106b). In certain embodiments, the first connection line 106a can be a suction line that draws a vacuum on the extractor 102, and the second connection line 106b can be a waste fluid return line through which fluid from the extractor 102 travels back to a recovery tank in the vehicle 104. In other embodiments, however, the waste fluid return line 106b can deliver the waste fluid to other suitable destinations including, for example, a drain or sewer.

The vehicle 104 can be a motor vehicle that includes a vehicle suction source 108 that can at least partially develop the vacuum within the extractor 102 via the first connection line 106a. In certain embodiments, the vehicle 104 can also include a propulsion engine 109 that primarily provides motive or propulsive force for the vehicle 104. In certain embodiments however, the vehicle engine 109 can also provide additional power to the vehicle suction source 108, for example, as disclosed in U.S. patent application Ser. No. 12/702,217, titled “SYSTEMS AND METHODS FOR TRANSFERRING HEAT AND/OR SOUND DURING FLUID EXTRACTION AND/OR CLEANING PROCESS,” filed Feb. 8, 2010, which is incorporated herein by reference in its entirety. To the extent the foregoing application and/or any other materials incorporated herein by reference conflict with the present disclosure, the present disclosure controls.

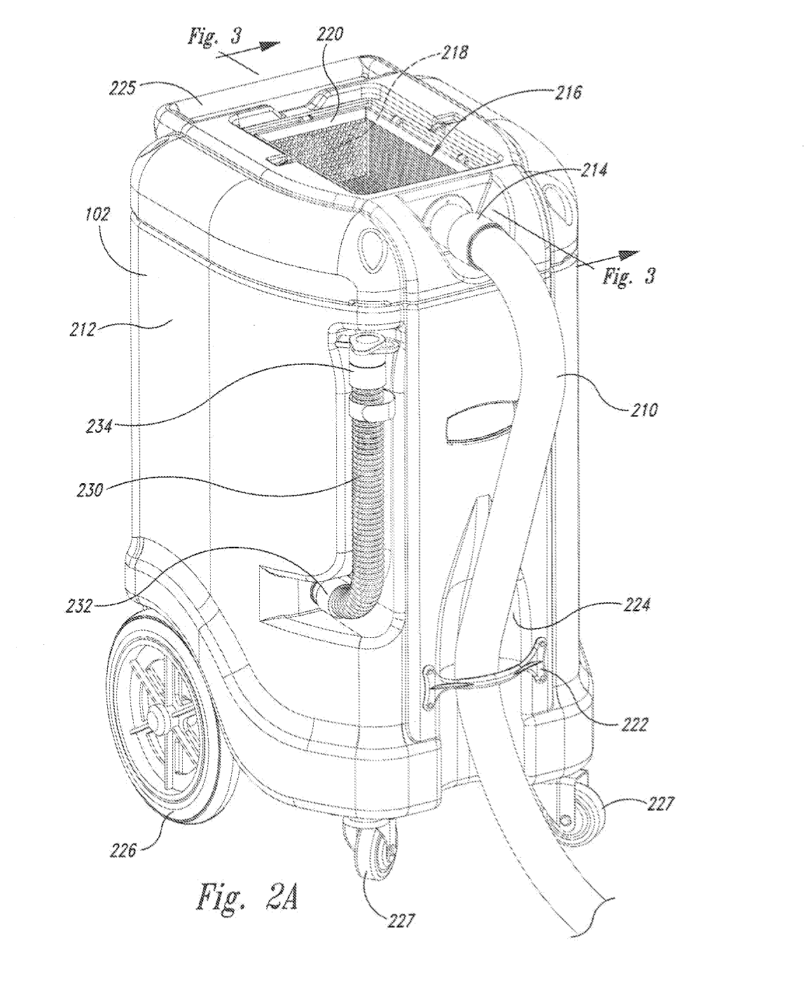

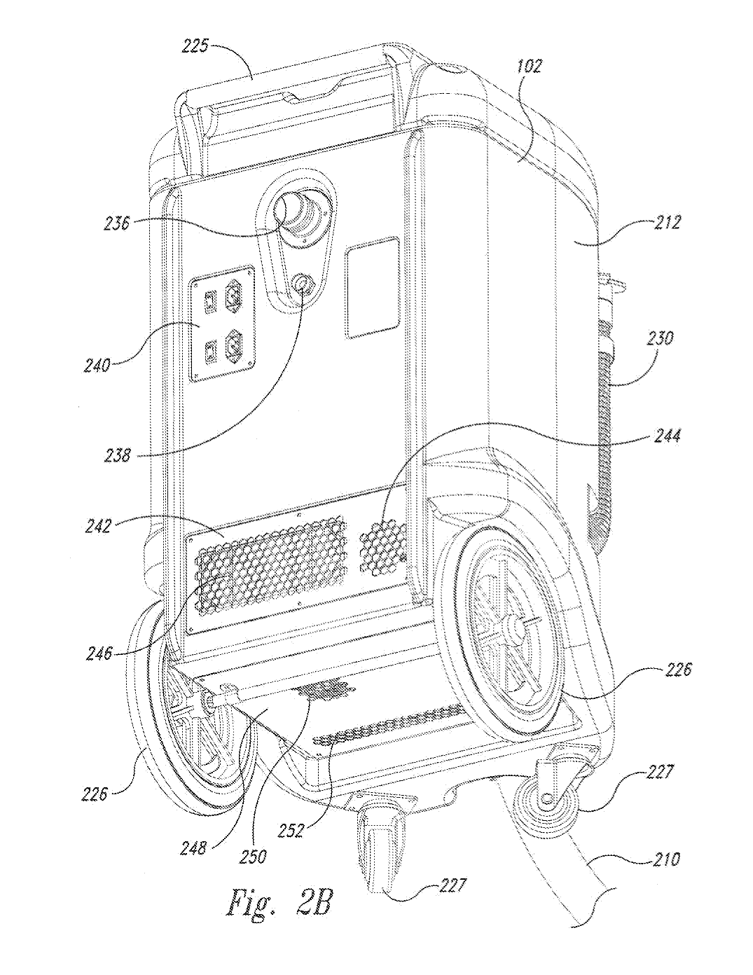

As explained in detail below, the extractor 102 can be used in a stand-alone mode that is separate from the vehicle suction source 108, as well as in combination with the vehicle suction source 108 as an increase or in-line boost to the vehicle suction source 108. Additional features of the extractor 102 are described below with reference to FIGS. 2A-4C.

FIG. 2A is a front isometric view and FIG. 2B is a rear isometric view of the extractor 102 of FIG. 1. Referring to FIGS. 2A and 2B together, the extractor 102 includes a cover or housing 212. As described in detail below, the housing 212 is configured to form several integral or single-piece features or components of the extractor 102. The extractor 102 also includes a fluid suction hose 210 operably coupled to the housing 212. More specifically, the extractor 102 includes an airflow inlet or suction hose connector 214 that couples one end of the suction hose 210 to the housing 212. An opposite end of the suction hose can be coupled to a vacuum head, squeegee, or other suitable vacuum directing attachment. Airflow entering the housing 212 from the suction hose 210 passes through a filter assembly 216 positioned at or near the top of the housing 212. The filter assembly 216 includes a cover 220 positioned adjacent to a filter 218. In certain embodiments, the cover 220 can be made from a clear material, such as a plastic or polycarbonate material, to allow a user to view the amount of fluid flowing from the suction hose 210 through the filter 218. Moreover, positioning the filter assembly 216 at or near the top of the housing 212 allows a user to easily view the filter assembly 216 during operation.

The extractor 102 also includes a handle or hose retainer 222 (FIG. 2A) positioned at a lower front portion of the housing 212. The hose retainer 222 spans or extends across a depression 224 (FIG. 2A) in a lower front portion of the housing 212. In certain embodiments, the suction hose 210 can be positioned at least partially within the depression 224 between the housing 212 and the hose retainer 222, in this manner, the hose retainer 222 can act as a strain relief for the suction hose connector 214 by at least partially limiting strain on the suction hose connector 214 as a user pulls the suction hose 210 to move the extractor 102. Moreover, the extractor 102 is also less likely to fall or tip over when the extractor 102 is pulled by the suction hose 210 and the suction hose 210 is positioned under the hose retainer 222. This is especially true when the extractor 102 is full or at least partially full of fluid and accordingly has an elevated center of gravity. According to additional features of the illustrated embodiment, the hose retainer 222 can also function as a handle or grip for a user to hold or to move the extractor 102. In the illustrated embodiment, for example, the hose retainer 222 is positioned at a lower portion of the housing 212 to be located generally at or below a center of mass of the extractor 102. Positioning the hose retainer 222 at a lower portion of the housing 222 can accordingly allow a user to more easily pull or otherwise move the extractor 102. In other embodiments, however, the hose retainer 222 can be positioned at other locations on the housing 212.

According to an additional feature of the illustrated embodiment, the extractor 102 includes a gravity drain hose or outlet 230 that is operably coupled to the housing 212. More specifically, the drain hose 230 includes a first portion 232 that can be fixedly attached to the housing 212 and coupled to a fluid retaining or waste fluid tank at least partially defined within the housing 212. A second end portion 234 of the drain hose 230 opposite the first end portion 232 can be removably coupled to an exterior portion of the housing 212 at a location that is above the first end portion 232. As such, a user can decouple the second end portion 234 from the housing and position the second end portion 234 below the first end portion 232 to drain the waste fluid contained within the housing 212 solely under the force of gravity.

The extractor 102 also includes a handle 225 extending from an upper rear portion of the housing 212, as well as rear wheels 226 and front wheels 227 extending from a lower portion of the housing 212. The handle 225 and wheels 226, 227 are designed to allow a user to easily move the extractor 102 to various locations. For example, the relatively larger rear wheels 226 are positioned at a rear lower portion of the extractor 102 generally beneath the handle 225, and the relatively smaller front wheels 227 are positioned at forward portion of the extractor 102 opposite the rear wheels 226. Moreover, the front wheels 227 can be configured to swivel or pivot to allow a user to steer the extractor 102 with the front wheels 227. A user can also the tip the extractor 102 back on the rear wheels 226 to move the extractor 102 solely on the rear wheels 226. The extractor 102 illustrated in FIGS. 2A and 2B is accordingly a portable extractor that a single user can easily roll or otherwise move to various locations.

According to additional aspects of the embodiment shown in FIG. 2B, the extractor 102 also includes a first airflow outlet or suction line connector 236 that is configured to receive or otherwise form a connection with a suction line from an optional additional suction source, such as the suction line 106a from the vehicle 104 shown in FIG. 1. The extractor 102 can further include a waste return connector or fluid exit connector 238 that is configured to receive or otherwise form a connection with a waste return line from an optional additional waste collector, such as the return line 106b from the vehicle 104 shown in FIG. 1. The extractor 102 can further include covers to seal the corresponding suction line connector 236 and fluid exit connector 238 when the extractor 102 operates in a stand-alone mode or otherwise without an additional suction source. At a rear portion of the housing 212 proximate to the suction line connector 236, the extractor 102 can also include a control panel 240 including two or more power switches corresponding to separate power circuits, and/or power cord receptacles for it movers, pumps, and/or other components as described in detail below.

As also shown in FIG. 2B at a lower portion of the housing 212, the extractor 102 includes a first screen or cover 242 at a rear side of the housing 212 and a second air screen or cover 248 at a bottom side of the housing 212. The first air screen 242 includes an air inlet portion 244 proximate to an air outlet portion 246, and the second air screen 248 also includes an air inlet portion 250 proximate to an air outlet portion 252. As explained in detail below, the first and second air screens 242, 244 cover one or more air movers that are positioned in the lower portion of the housing 212 and that generate suction airflow that passes through the housing 212.

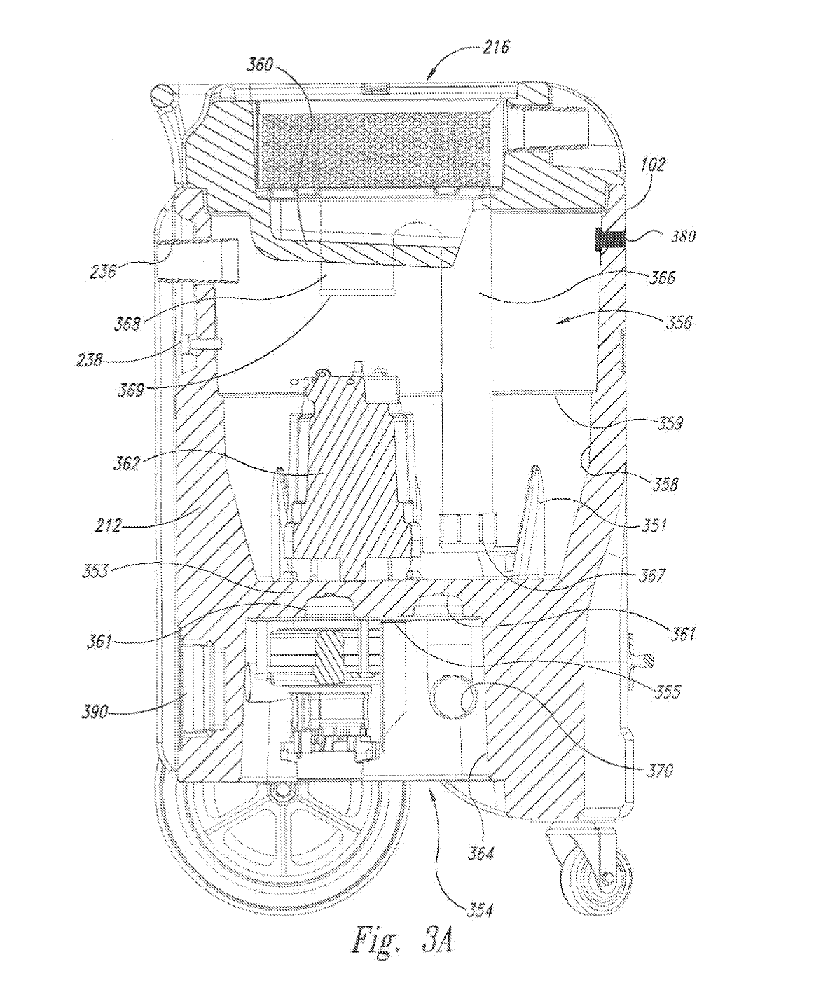

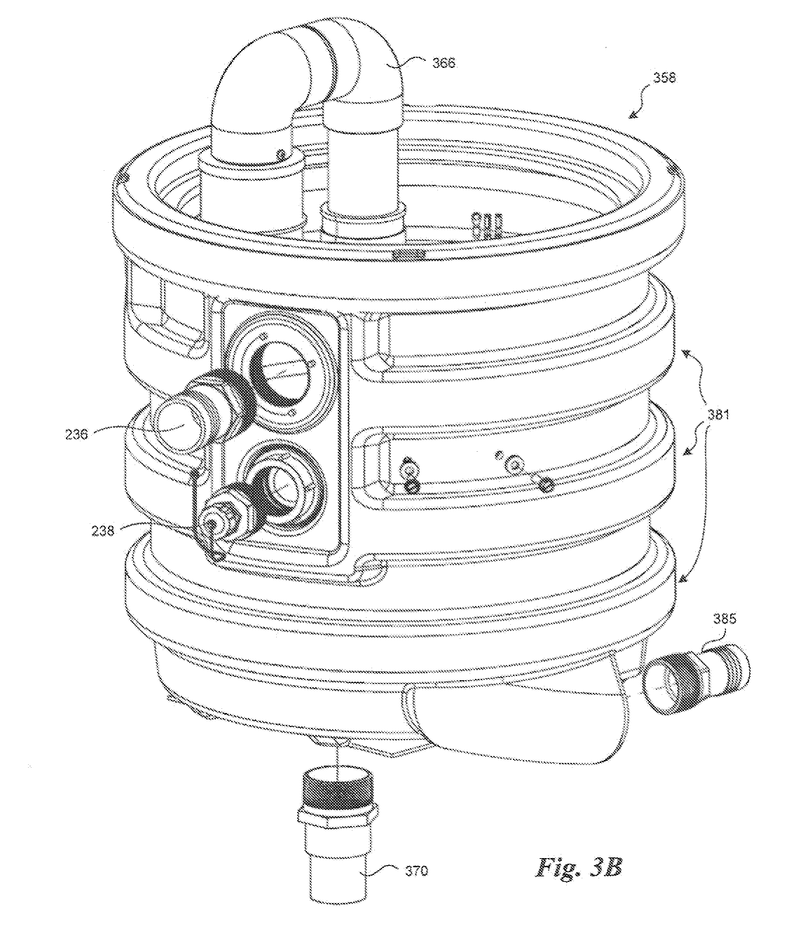

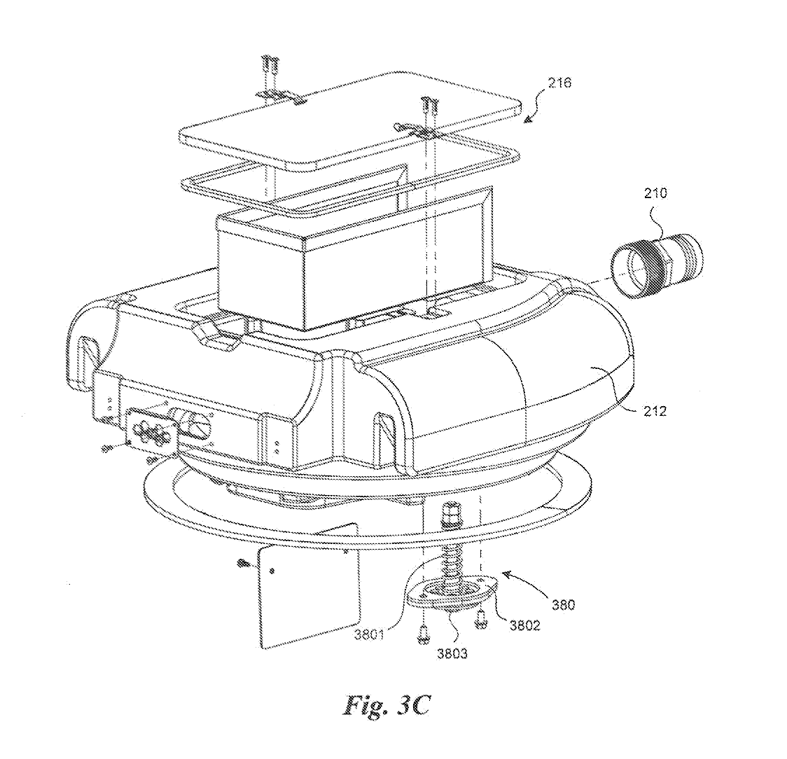

FIG. 3A is a side cross-sectional view taken substantially along line 3-3 of FIG. 2A illustrating several of the internal features of an embodiment of the extractor 102 and the housing 212. For example, in the illustrated embodiment the housing 212 includes a first or lower portion 354 positioned adjacent or beneath a second or upper portion 356. The upper portion 356 of the housing 212 includes a waste fluid tank 358 positioned below the filter assembly 216. The housing 212 further includes a fluid deflector or diverter 360 that supports the filter assembly 216. The fluid diverter 360 channels extracted fluid that passes through the filter assembly 216 into the waste fluid tank 358. The housing 212 further includes several integral stiffening features to strengthen the waste fluid tank 358. For example, the housing 212 includes first ribs or stiffeners 359 extending circumferentially around a mid-portion of the waste fluid tank 358. The housing 212 also includes second ribs or stiffeners 351 that project radially inwardly at a base portion of the waste fluid tank 358. As is also shown in the illustrated embodiment, the housing 212 can also define the waste fluid tank 358 to have a generally tapered or frustoconical shape. This tapered shape of the waste fluid tank 358 provides an increased wall thickness of the housing 212 at the lower or base portion of the waste fluid tank 358 to strengthen the waste fluid tank 358. As such, in certain embodiments, the housing 212 does not define the waste fluid tank 358 for maximum volume. Rather, the housing 212 can include one or more strengthening or stiffening features that may slightly reduce the volume of the waste fluid tank 358. In other embodiments, however, the housing 212 may define the waste fluid tank 358 to have other shapes including, for example, generally cylindrical, conical, or other suitable shapes. In other embodiments, the waste fluid tank 358 can be formed separately and positioned in the housing 212 (e.g., as shown and described with reference to FIG. 38 below).

The extractor 102 also includes another mechanism to empty extracted fluid from the waste fluid tank 358 in addition to the gravity drain hose 230 described above with reference to FIGS. 2A and 2B. More specifically, the extractor 102 also includes a fluid mover or pump 362 (e.g., a sump pump) positioned inside the waste fluid tank 358. The pump 362 can be a submersible or at least partially submersible pump as is known by those having ordinary skill in the art. The pump 362 can be coupled to a float switch or other suitable switch that can automatically activate the pump 362 when fluid within the waste fluid tank 358 rises to a predetermined level or at predetermined time intervals during operation. The pump 362 can also be coupled to the fluid exit connector 238 (FIG. 2B) via a hose or tube (not shown) to expel the extracted fluid from the waste fluid tank 358.

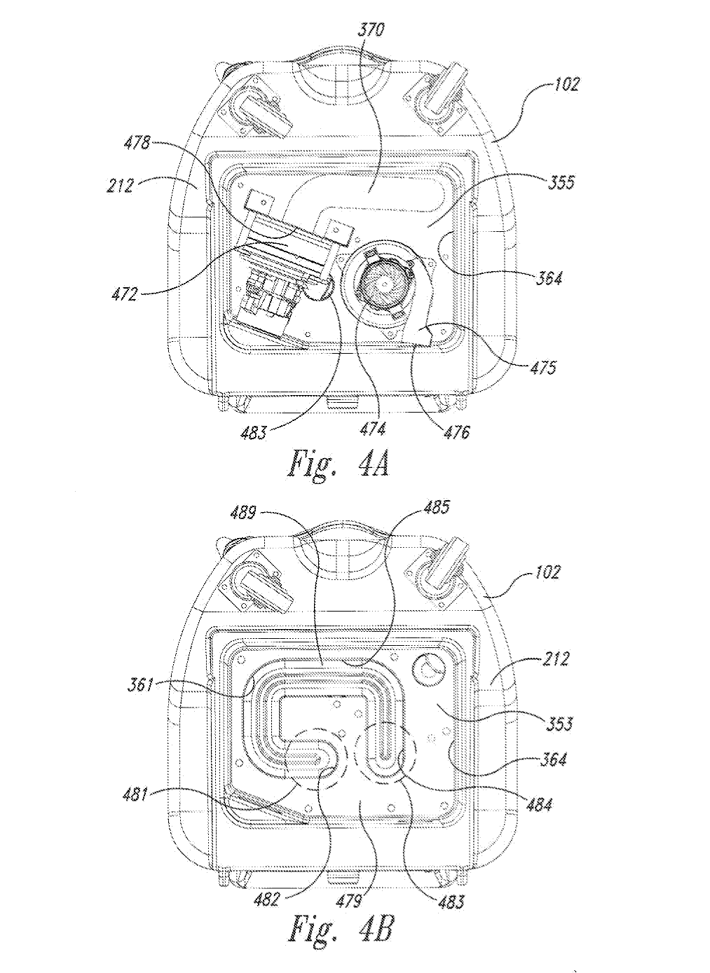

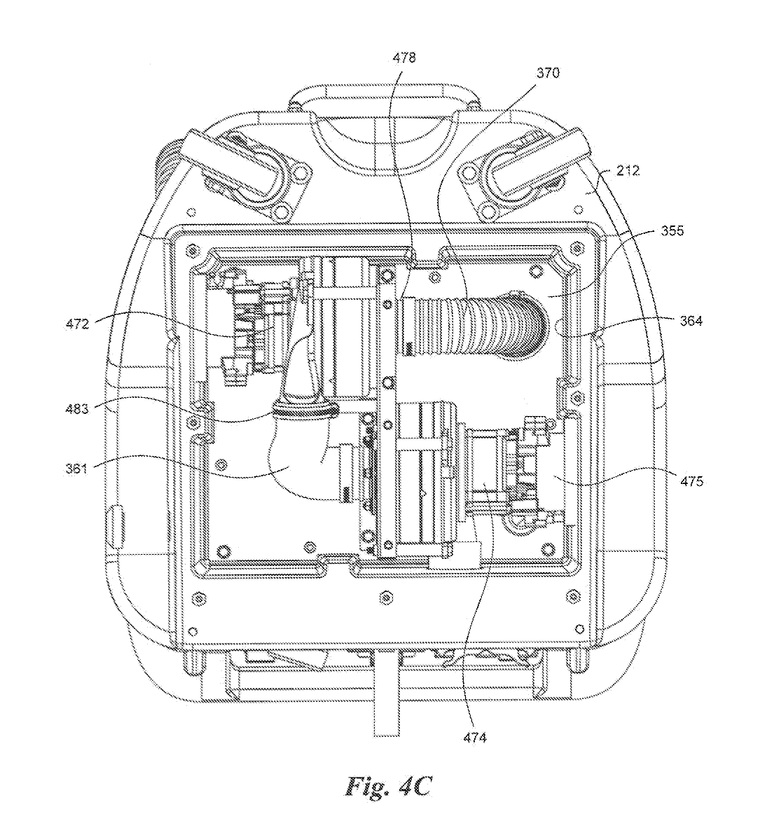

Suction or a vacuum can be developed within the waste fluid tank 358 via at least two different mechanisms to draw fluid into the waste fluid tank 358. For example, and as described above with reference to FIG. 1, the suction line 106a from the vehicle suction source 108 (FIG. 1) can be coupled to the first airflow outlet or suction line connector 236 (FIG. 2B) to at least partially draw a vacuum within the waste fluid tank 358. In the illustrated embodiment, the extractor 102 also includes one or more separate suction or vacuum sources carried in the lower portion 354 of the housing 212. More specifically, at the lower portion 354 of the extractor 102, the housing 212 includes an air mover cavity 364 that is positioned adjacent to the waste fluid tank 358. As described in detail below with reference to FIGS. 4A and 4B, one or more air movers or blowers can be positioned within the air mover cavity 364 and can be operably coupled to the waste fluid tank 358 to draw a vacuum or suction within the waste fluid tank 358. To fluidly connect the air mover cavity 364 to the waste fluid tank 358, the extractor 102 includes a first or upper suction tube 366 positioned in the waste fluid tank 358 that is fluidly coupled to a second or lower suction tube 370 that is positioned in the air mover cavity 364. The upper suction tube 366 has a first end portion 367 that is coupled to the lower suction tube 370 through a passage (not shown) extending through the housing 212. The upper suction tube 366 also has a second end portion 368 opposite the first end portion 367. The second end portion 368 includes a U-shaped or curved portion of the upper suction tube 366 that is positioned in an upper portion of the waste fluid tank 358. As such, an opening 369 of the second end portion 368 is positioned above a predetermined level of the extracted fluid that can be collected in the waste fluid tank 358 to thereby avoid drawing the extracted fluid into the upper suction tube 366. In certain embodiments, the second end portion 368 can include a stop valve or other type of fail-safe valve that blocks the upper suction tube 366 and stops the suction draw in the waste fluid tank 358 in the event that fluid reaches the opening 369 of the second end portion 368.

The extractor 102 can include a pressure relief valve 380 positioned in the housing 212 to control (e.g., adjust or limit) the air pressure inside the waste fluid tank 358. The pressure relief valve 380 can at least partially equalize the pressure (e.g., reduce the pressure difference) inside and outside the waste fluid tank 358 so as to prevent the waste fluid tank 358 from collapsing under high vacuum. In the illustrated embodiment, the pressure relief valve 380 can have any of a number of suitable configurations (e.g., as described further below with reference to FIG. 3C), in the illustrated embodiment of FIG. 3A, the extractor 102 can also include an outlet filter 390 to filter the airflow before it is exhausted. The filter 390 can be made of fibers or other suitable materials. For example, the outlet filter 390 can be a HEPA (High-Efficiency Particulate Air) filter.

As additionally described in detail below with reference to FIGS. 4A and 4B, the housing 212 further defines an airflow path 361 that extends between separate air movers positioned within the air mover cavity 364. More specifically, the housing 212 includes a dividing portion or wall 353 positioned between the air mover cavity 364 and the waste fluid tank 358. The airflow path 361 can include a channel or depression formed in the dividing wall 353 of the housing 212. The airflow path 361 can be enclosed with an air mover cover 355 that contacts a lower surface of the dividing wall 353 in the air mover cavity 364. Since the airflow path 361 is positioned adjacent to the waste fluid tank 358, heat from air traveling through the airflow path 361 can be transferred to extracted fluid that is contained within the waste fluid tank 358. As explained below, transferring this heat from the airflow can increase the longevity of the air movers used in the extractor 102. In addition to or in lieu of the airflow path 361 at least partially formed in the housing 212, according to several additional features of the extractor 102 illustrated in FIG. 3A, several of the features of the extractor 102 described above are integral components or features of the housing 212. For example, the waste fluid tank 358, the diverter 360, the stiffeners 359, 380, and/or the air mover cavity 364 can all be formed as an integral feature or component of the housing 212 or otherwise defined by portions of the housing 212.

FIG. 3B is a top isometric view of a waste fluid tank configured in accordance with embodiments of the present disclosure, in the illustrated embodiment, the waste fluid tank 358 is manufactured separately from the housing 212 and can be formed by a rotational molding for “rotomold”) process. As shown in FIG. 38, the waste fluid tank 358 can be cylindrical in shape. The waste fluid tank 358 can include a plurality of ribs 381 that provide and/or improve the structural strength of the waste fluid tank 358. In other embodiments, the ribs 381 can have different shapes, sizes, or arrangements. For example, in other embodiments, the ribs 358 can be formed on the inner surface of the waste fluid tank 358, in addition to or in lieu of the outer surface. Similar to the embodiments described with reference to FIG. 3A, the upper suction tube 366 can be positioned in the waste fluid tank 358 and is coupled in fluid communication with a lower suction tube 370, which is connected to one or more air movers described later. In the illustrated embodiment, the fluid in the waste fluid tank 358 can be drained out through a gravity drain tube 385 or via the pump 362 (FIG. 3A).

FIG. 3C is a top isometric view of an upper portion of the housing 212 and a pressure relief valve 380 configured in accordance with particular embodiments of the present disclosure. The pressure relief valve 380 can be positioned so as to control (e.g., adjust or limit) the pressure inside the waste fluid tank 358. For example, in the embodiment shown in FIG. 3C, the pressure relief valve 380 can be positioned in the upper portion of the housing 212. In other embodiments, the pressure relief valve 380 can be positioned, in the housing portion that defines the waste fluid tank 358 (see FIG. 3A).

As discussed above, the pressure relief valve 380 can control e.g., adjust or limit) the air pressure in the waste fluid tank 358, so as to prevent an accidental or unexpected low internal pressure from crushing the waste fluid tank 358. In the embodiment shown in FIG. 3C, the pressure relief valve 380 can include a spring 3801, a plate 3802, and a center portion 3803. The spring 3801 is slidably attached to the center portion 3803 and the plate 3802. When the pressure inside the waste fluid tank 358 is below a predetermined threshold value, a force created by the pressure difference inside and outside the waste fluid tank 358 can activate the pressure relief valve 380 (e.g., by compressing the spring 3801) so as to allow the pressure inside the waste fluid tank 358 to increase.

FIG. 4A is a bottom plan view of the extractor 102 with the second or lower cover 248 (FIG. 2B) removed for purposes of illustration. As shown in the illustrated embodiment, the housing 212 is molded or otherwise formed to define the air mover cavity 364 in a single-piece or unitary construction. A first air mover 472 and a second air mover 474 are each positioned within the air mover cavity 364. The first and second air movers 472, 474 can be centrifugal fans, squirrel cage blowers, and/or other suitable devices. In any of these embodiments, the first and second air movers 472, 474 can draw airflow through the extractor 102 to at least partially generate the suction within the extractor 102. The first and second air movers 472, 474 are fluidly coupled to the waste fluid tank 358 (FIG. 3A). To form this connection, the lower suction tube 370 extends from the waste fluid tank 358 (FIG. 3A) and is coupled to an inlet portion 478 of the first air mover 472. The first air mover 472 is also fluidly coupled to the second air mover 474 in-line or in series through the airflow path 361 (described above with reference to FIG. 3A and described in further detail below with reference to FIG. 4B). More specifically, an outlet 483 of the first air mover 472 is coupled to an entry portion of the airflow path 361, and an inlet of the second air mover 474 is coupled to an exit portion of the airflow path 361. The second air mover 474 expels the airflow through an outlet 475 that is aligned with an opening 476 in a lower rear portion of the housing 212. As discussed above, the outlet filter 390 (FIG. 3A) can filter the airflow before it is exhausted from the extractor 102. In some embodiments, the filter 390 can be a HEPA filter. Additional features of the airflow path 361 connecting the first and second air movers 472, 474 are described below with reference to FIG. 4B.

FIG. 4B is a bottom plan view of the extractor 102 with the first and second air movers 472, 474 and the air mover cover 355 (FIG. 4A) removed from the air mover cavity 364 to illustrate an airflow path 361 that extends between the locations of the first and second air movers 472, 474. As shown in FIG. 4B, the airflow path 361 includes a connecting portion 485 extending between an inlet portion 482 to an exit portion 484. The inlet portion 482 is generally aligned with the outlet 483 of the first air mover 472 (FIG. 4A) as represented by first broken lines 481, and the exit portion 484 is generally aligned with the inlet of the second air mover 474 (FIG. 4A) as represented by second broken lines 483. Moreover, the airflow path 361 is formed in the dividing wall 353 of the extractor housing 212. More specifically, the airflow path 361 is formed as a depression or channel in the dividing wall 353, which forms an upper surface of the air mover cavity 364. As such, the airflow path 351 is a reduced thickness portion of the dividing wall 353. Moreover, the airflow path 361 is defined in part by or includes a heat transfer surface 489 of the dividing wall 353. The heat transfer surface 489 is positioned at the dividing wall 353 adjacent to and opposite of the waste fluid tank 358 (FIG. 3A) to transfer heat from air passing through the airflow path 361 to extracted fluid contained within the waste fluid tank 358. When the air mover cover 355 (FIG. 4A) is positioned adjacent to the upper surface 479, the combined air mover cover 355 and upper surface 479 generally define the airflow path 361.

According to additional features of the embodiment illustrated in FIG. 4B, the airflow path 361 has a generally serpentine or non-linear shape. More specifically, the connecting portion 485 has one or more curved sections forming corresponding bends along the airflow path 361 between the inlet portion 482 and the exit portion 483. In this manner, the airflow path 361 has an elongated length extending between the inlet portion 482 and the exit portion 483. This elongated length and curved shape increases the distance air travels along the airflow path 361 thereby enhancing heat transfer from the aft flowing from the first air mover 472 to the second at mover 474 (FIG. 4A). More specifically, because the airflow path 361 is formed in the portion of the housing 212 that is the dividing wall 353 between the air mover cavity 364 and the waste fluid tank 358, heat from the air traveling along the airflow path 361 can be transferred to or otherwise absorbed by the extracted fluid in the waste fluid tank 358.

FIG. 4C is a bottom plan view of an extractor configured in accordance with embodiments of the present disclosure As shown in the illustrated embodiment, the housing 212 is molded or formed in a single-piece or unitary construction to define the air mover cavity 364. A first air mover 472 and a second air mover 474 are each positioned within the air mover cavity 364. The first and second air movers 472, 474 can both be centrifugal fans. In other embodiments, the first and second air movers 472, 474 can include other suitable air movers or blowers that draw airflow through the extractor 102 to at least partially generate the suction within the extractor 102. The first and second air movers 472, 474 are coupled in fluid communication with the waste fluid tank 358 (FIG. 3A) via the lower suction tube 370. The lower suction tube 370 is coupled to an inlet portion 478 of the first air mover 472. In the illustrated embodiment, the first air mover 472 is coupled to the second of mover 474 in series. More specifically, the outlet 483 of the first air mover 472 is coupled to an inlet of the second air mover 474, in this embodiment, the airflow path 361 between the first and second air movers 472, 474 can include a connector, a tube, or other suitable device. In other embodiments, the first and second air movers 472, 474 can be coupled in parallel. The second air mover 474 can expel the airflow through an outlet 475. In the illustrated embodiment, the heat carried by the air can be transferred to the waste fluid tank 358 through the air mover cover 355 and/or the air passing through the upper suction tube 366 and the lower suction tube 370. In some embodiments, the air is heated by the air movers 472, 474, and/or by heat sources external to the extractor 102.

Several features of extractors configured in accordance with embodiments of the present disclosure provide several advantages over conventional extractors. One advantage, for example, is that the extractors disclosed herein can reduce the wear experienced by the onboard air movers carried by the extractors by transferring heat from the airflow path between the air movers to extracted water that is contained within the corresponding waste fluid tanks. Another advantage is that the extractors disclosed herein can operate in multiple suction modes to extract fluids. For example, in a first suction mode an extractor as disclosed herein can generate suction solely with one or more air movers that are carried by the extractor. In a second suction mode, the extractor can be used in combination with an additional suction source that is separate from the extractor, such as a vehicle suction source 108 as described above with reference to FIG. 1. As such, the extractor can operate as an in-line booster for the secondary suction source. Operating as an in-line booster may be helpful, for example, in situations where the suction line from the secondary suction source is located at a significant distance from the target fluid to be extracted, thereby causing a pressure drop in the suction line. The extractor, can reduce, compensate, or eliminate such pressure drops, or even increase the overall suction generated in the extractor.

From the foregoing, it will be appreciated that specific embodiments of the disclosure have been described herein for purposes of illustration, but that various modifications may be made without deviating from the scope of the disclosure. For example, the cavities and channels formed by the housing described above may have different features, arrangements, and/or elements than those explicitly described above without deviating from the disclosure. Moreover, the air movers carried by the extractor can include more than two or less than two air movers. In addition, aspects described in the context of particular embodiments may be combined or eliminated in other embodiments. Further, although advantages associated with certain embodiments have been described in the context of those embodiments, other embodiments may also exhibit such advantages, and not all embodiments need necessarily exhibit such advantages to fail within the scope of the disclosure.

I/We claim:

1. An extractor for removing fluid from a surface, the extractor comprising:
a waste fluid tank positioned to receive extracted waste fluid;
an air mover proximate to the waste fluid tank;
a first airflow connector coupling the air mover to the waste fluid tank for drawing a vacuum in the waste fluid tank; and
a second airflow connector operably coupled to the waste fluid tank, wherein the second airflow connector is positioned to be coupled to a suction source that is spaced apart from the extractor.

2. The extractor of claim 1, further comprising a unitary housing that at least partially defines each of the waste fluid tank and an air mover cavity, the air mover cavity at least partially housing the air mover.

3. The extractor of claim 1 wherein the air mover is adjacent to the waste fluid tank and is located beneath the waste fluid tank when the extractor is in an upright position.

4. The extractor of claim 1 wherein the air mover is a first air mover and the extractor further comprises a second air mover positioned proximate to the first air mover, wherein the second air mover is positioned to draw the vacuum in the waste fluid tank via the first airflow connector.

5. The extractor of claim 4, further comprising:
a housing that at least partially encloses the first air mover and the second air mover; and
an airflow path extending from the first air mover to the second air mover, wherein the airflow path is formed in at least a portion of the housing.

6. The extractor of claim 5 wherein the airflow path has one or more curved portions extending between the first air mover to the second air mover.

7. The extractor of claim 4 wherein an airflow path formed in the housing is positioned adjacent to the waste fluid tank and includes a heat transfer surface positioned to transfer heat from air flowing through the airflow path to extracted waste fluid contained within the waste fluid tank.

8. The extractor of claim 1, further comprising:
a pump positioned in the waste fluid tank;
a waste fluid outlet operably coupled to the pump to deliver pressurized waste fluid from the pump out of the waste fluid tank;
a pressure relief valve positioned to control the air pressure in the waste fluid tank; and
an outlet filter positioned to filter air propelled by the air mover before the air is exhausted.

9. The extractor of claim 8 wherein the waste fluid outlet is a first waste fluid outlet, and wherein the extractor further comprises a second waste fluid outlet positioned below the waste fluid tank to deliver waste fluid out of the waste fluid tank solely under the force of gravity.

10. An extractor comprising
a housing;
a waste fluid tank positioned in the housing to receive extracted waste fluid;
a first air mover proximate to the waste fluid tank, wherein the first air mover has an air outlet;
a second air mover proximate to the waste fluid tank, wherein the second air mover has an air inlet; and
an airflow path at least partially defined by the housing, wherein the airflow path couples the air outlet of the first air mover to the air inlet of the second air mover, and wherein the airflow path includes a heat transfer surface positioned to transfer heat from air flowing through the airflow path to extracted waste fluid in the waste fluid tank.

11. The extractor of claim 10 wherein the waste fluid tank aria the airflow path are positioned on opposing adjacent sides of a wall of the housing.

12. The extractor of claim 10 wherein the housing includes a wall having a first side opposite a second side, wherein the first side of the wall faces the waste fluid tank and the second side of the wall faces at least partially defines the heat transfer surface.

13. The extractor of claim 10 wherein the first air mover is arranged in series with the second air mover along the airflow.

14. The extractor of claim 10 wherein the airflow path is nonlinear between the first air mover and the second air mover.

15. A fluid extraction system comprising:
a fluid extractor having—
a waste fluid tank positioned to contain extracted waste fluid;
a first suction source operably coupled to the waste fluid tank to draw a vacuum in the waste fluid tank; and
a suction hose connector positioned to be coupled to a second suction source separate from the first suction source and external to the fluid extractor to draw the vacuum in the waste fluid tank;
wherein the fluid extractor is operable in a first mode and a second mode, wherein in the first mode the first suction source draws the vacuum in the waste fluid tank and in the second mode the combined first and second suction sources draw the vacuum in the waste fluid tank.

16. The fluid extraction of claim 15 wherein the second suction source comprises a motor vehicle coupled to a suction hose that is releasably coupleable to the suction hose connector.

17. The fluid extraction system of claim 15 wherein the first suction source comprises:
a first air mover carried by the fluid extractor; and
a second air mover carried by the fluid extractor and fluidly coupled in series with the first air mover.

18. The fluid extraction system of claim 15 wherein the fluid extractor further comprises a pump operably coupled to the waste fluid tank, wherein the pump is positioned to expel pressurized waste fluid from the waste fluid tank.

19. A method of manufacturing an extractor, the method comprising:
forming an extractor housing, the housing at least partially defining—
a fluid exit operably coupled to a waste fluid tank;
a first airflow outlet operably coupled to the waste fluid tank;
an air mover cavity proximate to the waste fluid tank and operably coupled to the waste fluid tank;
a heat transfer wall positioned between the waste fluid tank and the air mover cavity; and
a second airflow outlet operably coupled to the air mover cavity;
positioning an air mover in the air mover cavity;
operably coupling the air mover to the second airflow outlet;
positioning a pump in the waste fluid tank; and
operably coupling the pump to the fluid exit.

20. The method of claim 19 wherein forming the extractor housing comprises forming the waste fluid tank and the air mover cavity from an integral portion of the housing.

21. The method of claim 19 wherein forming the extractor housing comprises forming an airflow path in the heat transfer wall, the airflow path being operably coupled to the air mover.

22. The method of claim 21 wherein forming the airflow path comprises forming a channel in at least a portion of the heat transfer wall of the housing.

23. The method of claim 19 wherein the fluid exit is a first fluid exit, and wherein forming the extractor housing further comprises forming a second fluid exit operably coupled to the waste fluid tank to allow fluid to exit the waste fluid tank under the force of gravity.

24. The method of claim 19 wherein positioning the air mover comprises positioning a first air mover in the air mover cavity, the method further comprising positioning a second air mover in the air mover cavity.

25. A method of operating a fluid extractor, the method comprising:
in a first operational mode of the extractor, drawing a vacuum in a waste fluid tank with a first vacuum source to draw fluid into the waste fluid tank, wherein the first vacuum source is carried by the extractor; and
in a second operational mode of the extractor, drawing the vacuum in the waste fluid tank with a second vacuum source in combination with the first vacuum source to draw fluid into the waste fluid tank, wherein the second vacuum source spaced apart from the extractor.

26. The method of claim 25 wherein in the second operational mode the first vacuum source supplements the second vacuum source to at least partially compensate for a pressure drop from the second vacuum source.

27. The method of claim 25, further comprising:
in a first emptying mode, emptying pressurized fluid from first outlet in the waste fluid tank with a pump carried by the extractor; and
in a second emptying mode, emptying fluid from a second outlet in the waste fluid tank under the force of gravity.

28. The method of claim 25 wherein drawing the vacuum in the waste fluid tank with the first vacuum source comprises drawing the vacuum with a first air mover and a second air mover, wherein the first and second air movers are carried by the extractor.

29. The method of claim 25, further comprising transferring heat from airflow through the first vacuum source to fluid contained within the waste fluid tank.

30. The method of claim 29 wherein:
in the first operation mode of the extractor, drawing the vacuum in the waste fluid tank with the first vacuum source carried by the extractor comprises drawing the vacuum with a first air mover spaced apart from a second air mover; and
transferring heat from airflow through the first vacuum source to fluid contained within the waste fluid tank comprises transferring heat from an airflow path coupling the first air mover to the second air mover, the airflow path having a heat transfer surface adjacent to the waste fluid tank.
